(19) United States
(12) Patent Application Publication
(10) Pub. No.: US 2012/0244977 A1
(43) Pub. Date: Sep. 27, 2012

(54) Bicycle cogset

(76) Inventor: Chia-Wei LIAO, Taichung City (TW)

(21) Appl. No.: 13/069,716

(22) Filed: Mar. 23, 2011

(51) Int. Cl. B62M 9/10

(52) U.S. Cl. 474/160

(57) ABSTRACT

A cogset, which is adapted to connect to a rotatable hub in a bicycle, comprises a cog assembly and a connective set installed to the cog assembly. The cog assembly includes at least one first cog, a second cog connected to the first cog, and a third cog connected to the first cog. Each of the first and second cogs are not directly connected to the rotatable hub.

### BACKGROUND OF THE INVENTION

1. Field of the Invention

The present invention relates to a cogset with improved reliability and repairability whose components can be easily and securely installed to each other. More particularly, the cogset has the advantage of being very lightweight.

2. Description of the Related Art

U.S. Publication No. 2005/0272546 shows a riveted sprocket assembly that includes a sprocket carrier having a plurality of carrier arms and a plurality of sprockets attached to the carrier arms by rivets. First and second rivet heads of the rivets are countersunk into the carrier arms on one face and into the sprocket on the other face. The second rivet head is formed on the sprocket on the front face of the sprocket carrier. To prevent the riveting tool from damaging the sprocket during the riveting process, the rivet holes of the sprockets include a clearance portion around the second rivet head. This clearance results in the sprocket having three-stepped rivet holes: a small diameter for the rivet shaft, an intermediate diameter for the rivet head and a larger diameter for the riveting tool. To minimize weight, the carrier arms narrow in a central region between radially inner and radially outer rivet holes on the carrier arms. The sprocket facilitates the maintenance of the riveted sprocket assembly. However, each carrier arm is substantially stair-shaped for attaching a plurality of sprockets and the thickness of the carrier arm increases form an end attaching a smallest sprocket to another end attaching a largest sprocket. Therefore, the increasing thickness entails substantially excess weight.

U.S. Pat. No. 7,344,463 shows a sprocket assembly that includes at least three sprockets and a sprocket carrier having a plurality of radially extending carrier arms. The carrier arms include a first receiving surface and a second receiving surface opposite the first receiving surface. A first sprocket mounted to the first receiving surface and a second sprocket mounted to the second receiving surface. A third sprocket arranged between the first and second sprockets. The first, second and third sprockets are directly mounted onto the sprocket carrier, hence, each carrier arm still has a excess thickness delimited from first sprocket to second sprocket for supporting the first and second sprocket, and the excess thickness entails substantially excess weight.

The present invention is, therefore, intended to obviate or at least alleviate the problems encountered in the prior art.

### SUMMARY OF THE INVENTION

According to the present invention, the main purpose is to provide a cogset, which is adapted to connect to a rotatable hub in a bicycle, comprises a cog assembly and a connective set installed to the cog assembly. The cog assembly includes at least one first cog, a second cog connected to the first cog, and a third cog connected to the first cog. Each of the first and second cogs is not directly connected to the rotatable hub.

An advantage of the cogset according to the present invention is that each of the first and second cogs is not directly connected to the rotatable hub so that the diameter of the through hole of the first cog and the through hole of the second cog can be maximized to decrease the weight of the cogset.

Another advantage of the cogset according to the present invention is that each of the first, second, and third connectors has a profile the same with each other such that the cost is reduced.

Another advantage of the cogset according to the present invention is that a diameter of the recess of the each first cog is larger than the fifth diameter of the retaining portion of the connective set so that the connective set would not interfere with respect to the chain while operating.

Other advantages and features of the present invention will become apparent from the following description referring to the drawings.

### BRIEF DESCRIPTION OF THE DRAWINGS

FIG. 1 is a perspective view of a cogset according to the present invention.

FIG. 2 is an exploded perspective view of the cogset of FIG. 1.

FIG. 3 is another exploded perspective view of the cogset of FIG. 1.

FIG. 4 is a cross-section view taken along line 4-4 of FIG. 1.

FIG. 5 is a cross-section view taken along line 5-5 of FIG. 1.

FIG. 6 is a cross-section view taken along line 6-6 of FIG. 1.

FIG. 7 is a partial, enlarged view of FIG. 6 and shows a first connector is connected between a largest first cog and a second cog.

FIG. 8 is another partial, enlarged view of FIG. 6 and shows a second connector is connected between two first cogs.

FIG. 9 is another partial, enlarged view of FIG. 6 and shows a third connector is connected between a third cog and a smallest first cog.

FIG. 10 shows the cogset is adapted to connect to a rotatable hub in a bicycle.

FIG. 11 shows the rotatable hub is connected to a fixing element and the third cog.

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE PREFERRED EMBODIMENT

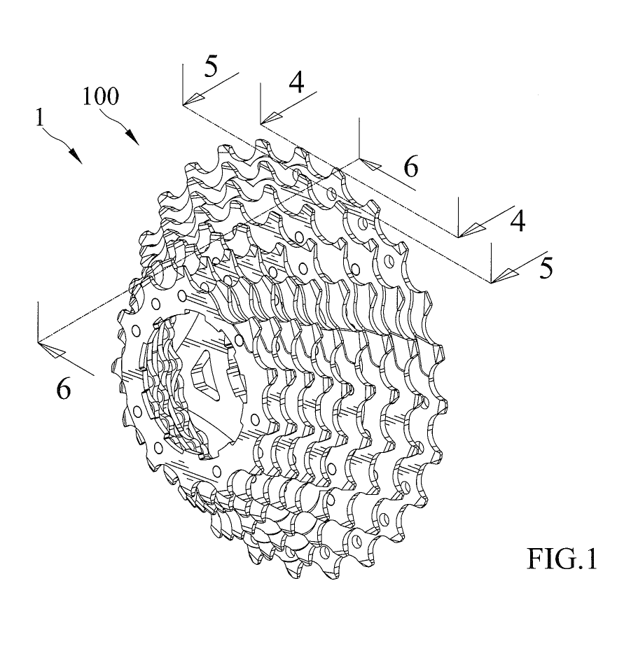

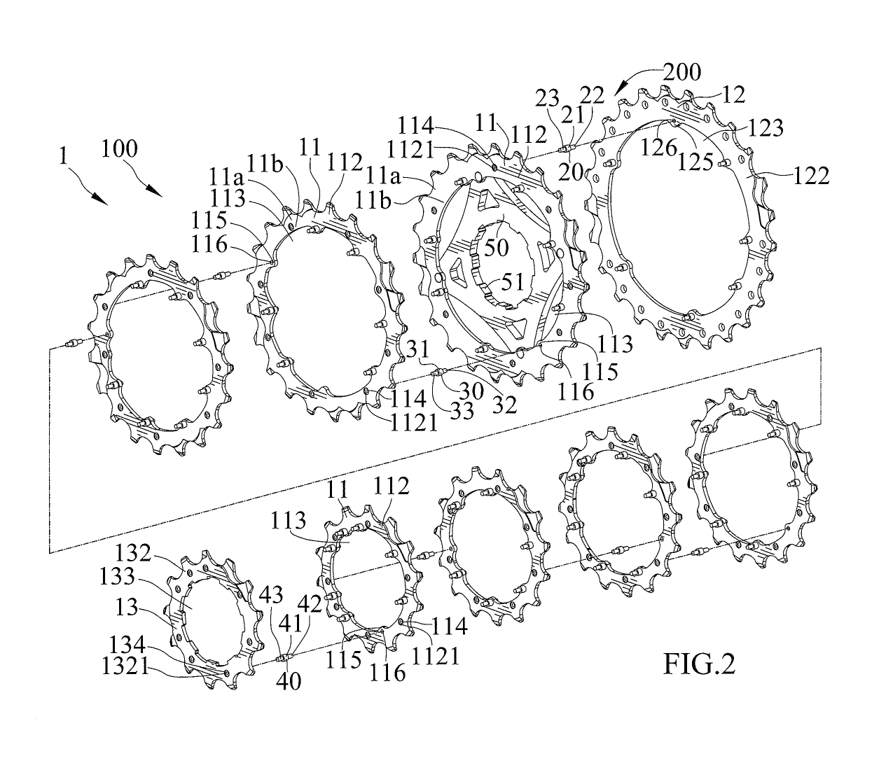

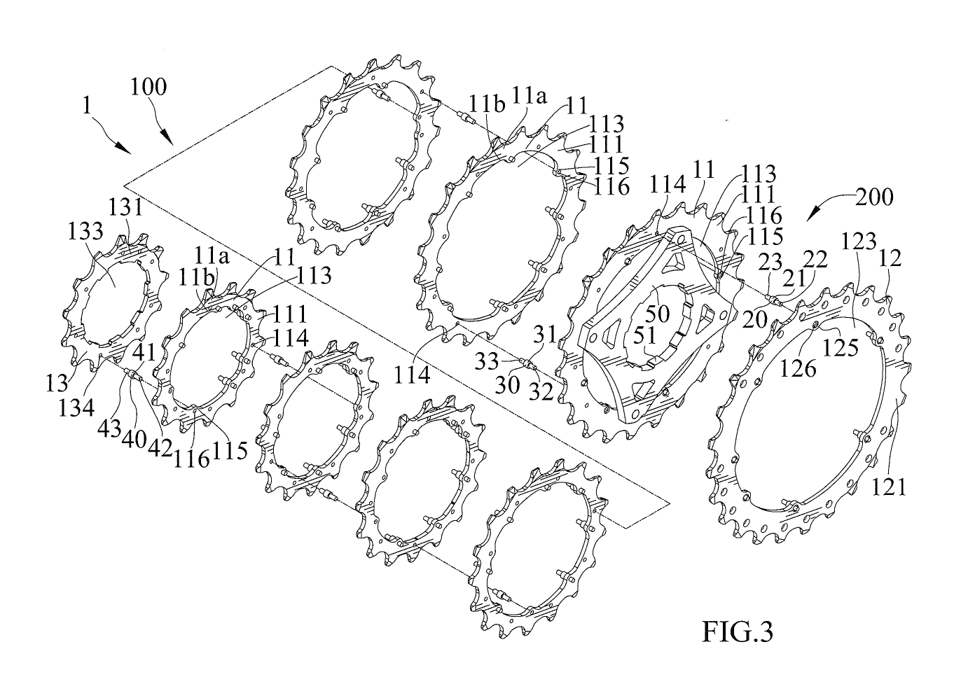

Referring to FIG. 1 to FIG. 3, a cogset assembly 1 in accordance with an embodiment of the present invention is adapted to connect to a rotatable hub in a bicycle. The cogset 1 comprises a cog assembly 100 and a connective set 200 installed to the cog assembly 100.

The cog assembly 100 includes at least one first cog 11, a second cog 12 connected to the first cog 11, and a third cog 13 connected to the first cog 11. Preferably, the cog assembly 100 includes seven first cogs 11, a second cog 12 and a third cog 13. Specifically, each of the first 11, second 12, and third 13 cogs includes a plurality of teeth formed around its outer peripheral edge to cooperate with a chain. Preferably, each of the first 11, second 12 and third 13 cogs has a radial distance, which is measured from a center thereof to an outer peripheral edge thereof, differentiates from one another in order to accomplish different bicycle speeds. Preferably, the radial distance of second cog 12 is larger than the radial distance of any first cog 11, and the radial distance of any first cog 11 is larger than the radial distance of third cog 13.

Each first cog 11 has two opposing sides including a first side 111 adjacent to the second cog 12 and a second side 112 distal from the second cog 12. Each first cog 11 includes a through hole 113 extending from the first side 111 to the second side 112 so as to decrease the weight of the first cog 11. Each first cog 11 further includes a first portion 11a distal from the related through hole 113 and a second portion 11b adjacent to the related through hole 113. Each first portion 11a has at least one aperture 114 extended from the first side 111 to the second side 112. Preferably, each first portion 11a has seven apertures 114 circularly distributed thereon. Each aperture 114 and the center of the related first cog 11 have a first distance therebetween. Each second side 112 has a recess 1121 formed thereon and in communication with related aperture 114. Each second portion 11b has at least one connected section 115 adjacent to an inner periphery of the through hole 113. Preferably, the second portion 112 of each first cog 11 has seven connected sections 115 circularly distributed thereon and extended toward the center of related first cog 11. Each connected section 115 has a positioning hole 116 extended from the first side 111 to the second side 112. Each positioning hole 116 and the center of the related first cog 11 have a second distance therebetween, and the second distance is smaller than the first distance. Preferably, the aperture 114 of smaller first cog 11 corresponds to the positioning hole 116 of larger first cog 11.

The second cog 12 is installed to the largest first cog 11 and has two opposing sides including a first side 121 distal from the first cog 11 and a second side 122 adjacent to the first cog 11. The second cog 12 includes a through hole 123 extending from the first side 121 to the second side 122 so as to decrease the weight of the second cog 12. The second cog 12 has at least one connected section 125 adjacent to an inner periphery of the through hole 123 and corresponding to the aperture 114 of the largest first cog 11. Preferably, the second portion 122 of each first cog 12 has seven connected sections 125 circularly distributed thereon and extended toward the center of the second cog 12. Each connected section 125 has a positioning hole 126 extended from the first side 121 to the second side 122. The positioning hole 126 of the second cog 12 and the aperture 114 of the largest first cog 11 are coaxial with each other.

The third cog 13 is installed to the smallest first cog 11 and has two opposing sides including a first side 131 adjacent to the first cog 11 and a second side 132 distal from the first cog 11. The third cog 13 includes a through hole 133 extending from the first side 131 to the second side 132 so as to connect to a rotatable hub in a bicycle. The third cog 13 further has at least one aperture 134 extended from the first side 131 to the second side 132 and corresponding to the positioning hole 116 of the smallest first cog 11. Preferably, the third cog 13 has seven apertures 134 circularly distributed thereon. Each second side 132 has a recess 1321 formed thereon and in communication with the aperture 134. The aperture 134 of the third cog 13 and the positioning hole 116 of the smallest first cog 11 are coaxial with each other.

The connective set 200 includes at least one first connector 20 disposed between the largest first cog 11 and the second cog 12, at least one second connector 30 disposed between the first cogs 11, and at least one third connector 40 disposed between the smallest first cog 11 and the third cog 13. Each of the first 20, second 30 and third 40 connectors is substantially column shaped and has a first portion 21, 31, 41, a second portion 22, 32, 42, and a third portion 23, 33, 43, respectively. Each of the first portion 21, 31, 41 is delimited between the related second portion 22, 32, 42 and the related third portion 23, 33, 43.

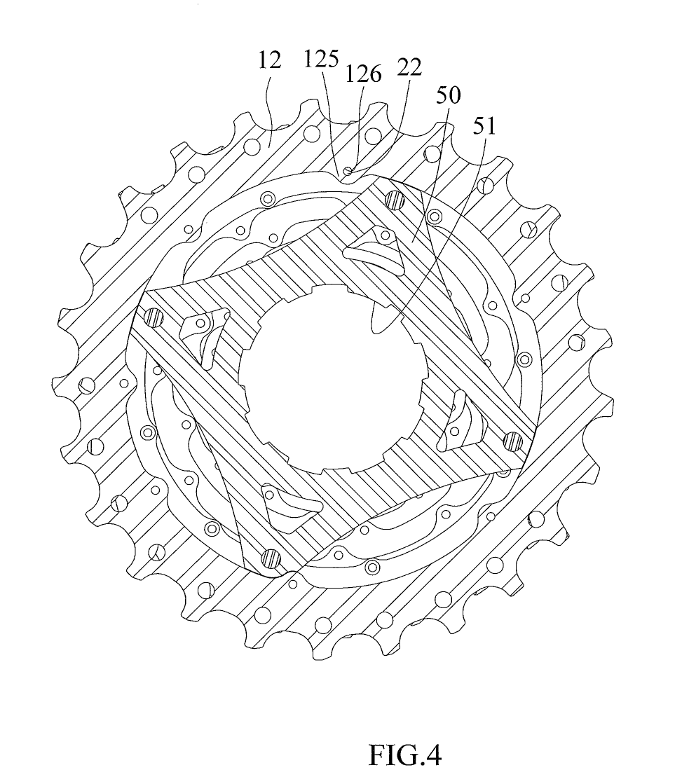

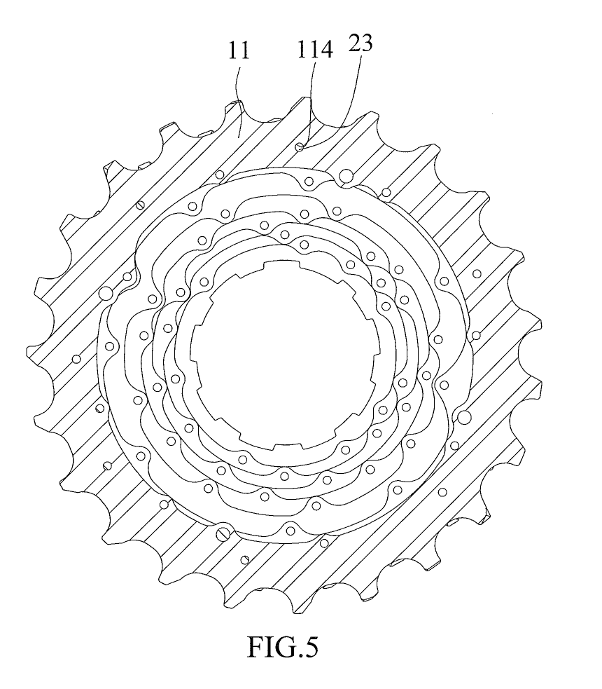

Referring to FIG. 4 and FIG. 5, the second portion 22 corresponds to and is installed to the positioning hole 126 of the second cog 12, and the third portion 23 corresponds to and is installed to the aperture 114 of the largest first cog 11. Preferably, the second portion 22 has a cross-section the same with that of the positioning hole 126, and the third portion 23 has a cross-section the same with that of the aperture 114, therefore, the first connector 20 is steadily disposed between the largest first cog 11 and second cog 12.

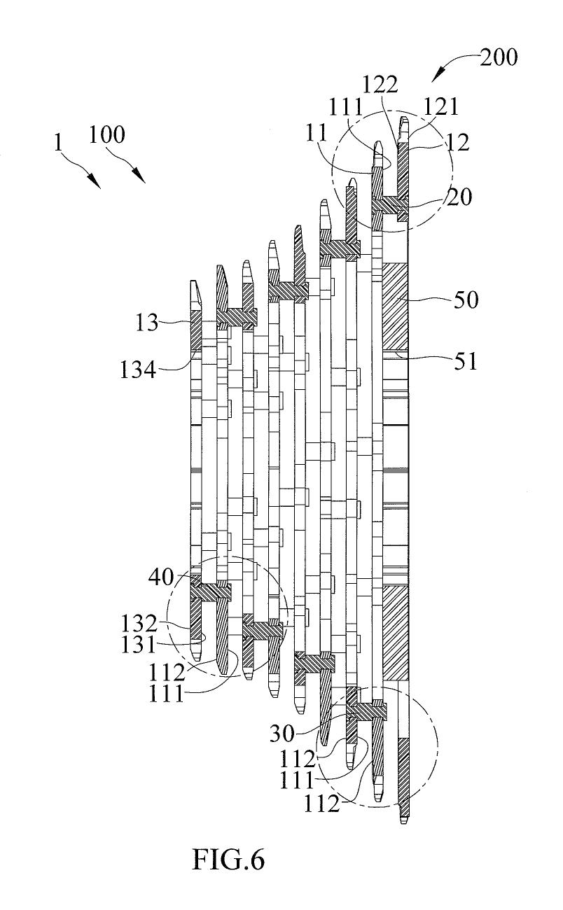

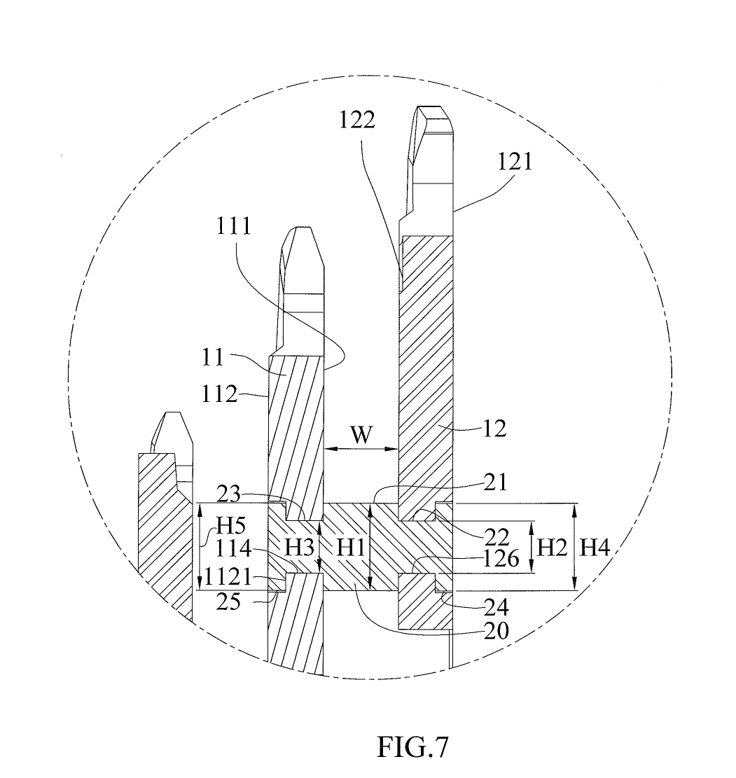

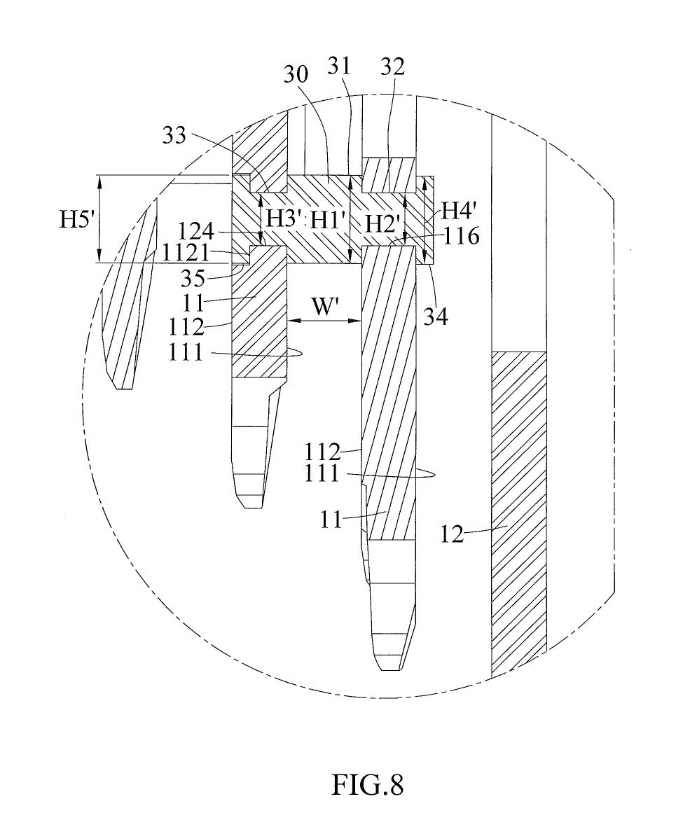

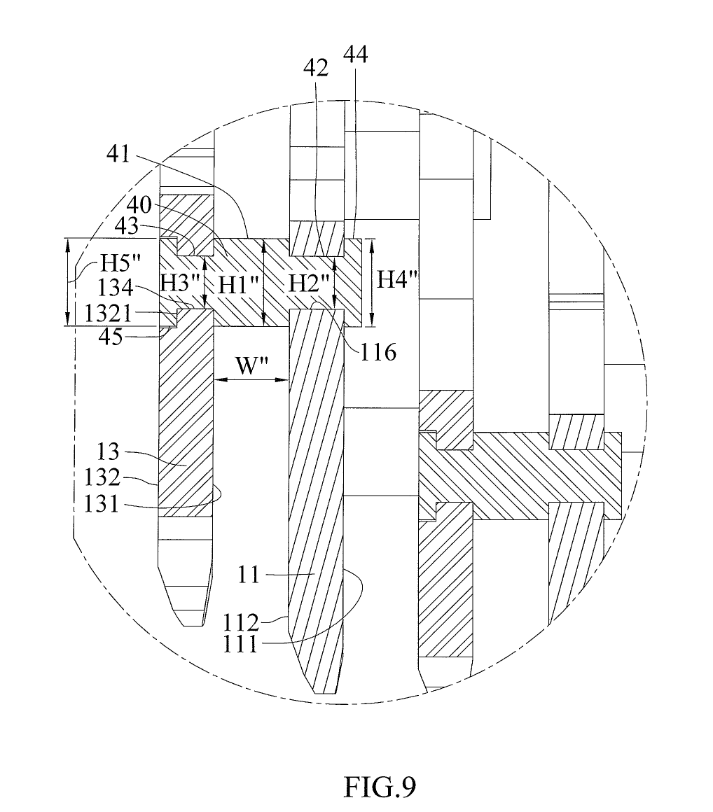

Referring to FIG. 6 through FIG. 9, each of the first portions 21, 31, 41 has a width W, W′, W″ along a longitudinal direction of related connector 20, 30, 40, and a first diameter H1, H1′, H1″ along a radial direction of related connector 20, 30, 40. each of the second portions 22, 32, 42 has a second diameter H2, H2′, H2″ along the radial direction of related connector 20, 30, 40. Each of the third portions 23, 33, 43 has a third diameter H3, H3′, H3″ along the radial direction of related connector 20, 30, 40. The first diameter H1, H1′, H1″ of each first portion 21, 31, 41 is larger than the second diameter H2, H2′, H2″ of related second portion 22, 32, 42, and is larger than the third diameter H3, H3′, H3″ of related third portion 23, 33, 43. In addition, the first diameter H1, H1′, H1″ of each first portion 21, 31, 41 is larger than the diameter of related positioning hole 116, 126 or aperture 114, 134. Both sides of the first portion 21 abut against the first side 111 of the largest first cog 11 and the second side 122 of the second cog 12, respectively, therefore, the largest first cog 11 and the second cog 12 have a gap therebetween, preferably, the gap is equivalent to the width W. The second portion 22 has a retaining portion 24 formed on one end thereof distal from the first portion 21. The third portion 23 has a retaining portion 25 formed on one end thereof distal from the first portion 21. The retaining portion 24 of the second portion 22 has a fourth diameter H4 along the radial direction of the first connector 20, and the retaining portion 25 of the third portion 23 has a fifth diameter H5 along the radial direction of the first connector 20. The fourth diameter H4 of the retaining portion 24 is larger than the diameter of the positioning hole 126 such that the second cog 12 is restrained between the first portion 21 and the retaining portion 24. The fifth diameter H5 of the retaining portion 25 is larger than the diameter of the aperture 114 of the largest first cog 11 such that the largest first cog 11 is restrained between the first portion 21 and the retaining portion 25. A diameter of the recess 1121 of the largest first cog 11 is larger than the fifth diameter H5 of the retaining portion 25 such that the retaining portion 25 is disposed in the recess 1121 of the largest first cog 11 and does not protrude from the second side 112 of the largest first cog 11, therefore, the first connector 20 would not interfere with respect to the chain while operating.

The first cogs 11 are connected with each other by the second connectors 30 in which the second portion 32 of each second connector 30 is installed to the positioning hole 126 of the larger first cog 11, and the third portion 33 of each second connector 30 is installed to the aperture 114 of the smaller first cog 11. Both sides of the first portion 31 abut against the first side 111 of the smaller first cog 11 and the second side 112 of the larger first cog 11, respectively, therefore, the larger and related smaller first cogs 11 have a gap therebetween, preferably, the gap is equivalent to the width W′. Preferably, the second portion 32 has a cross-section the same with that of the positioning hole 116 of each first cog 11, and the third portion 33 has a cross-section the same with that of the aperture 114 of each first cog 11, therefore, the second connector 30 is steadily disposed between the first cogs 11. The second portion 32 has a retaining portion 34 formed on one end thereof distal from the first portion 31. The third portion 33 has a retaining portion 35 formed on one end thereof distal from the first portion 31. The retaining portion 34 of the second portion 32 has a fourth diameter H4′ along the radial direction of the second connector 30, and the retaining portion 35 of the third portion 33 has a fifth diameter H5′ along the radial direction of the second connector 30. The fourth diameter H4′ of the retaining portion 34 is larger than the diameter of the positioning hole 116 of the larger first cog 11 such that the larger first cog 11 is restrained between the first portion 31 and the retaining portion 34. The fifth diameter H5′ of the retaining portion 35 is larger than the diameter of the aperture 114 of the smaller first cog 11 such that the smaller first cog 11 is restrained between the first portion 31 and the retaining portion 35. A diameter of the recess 1121 of the smaller first cog 11 is larger than the fifth diameter H5′ of the retaining portion 35 such that the retaining portion 35 is disposed in the recess 1121 of the smaller first cog 11 and does not protrude from the second side 112 of the smaller first cog 11, therefore, the second connector 30 would not interfere with respect to the chain while operating.

The third cogs 13 and the smallest first cog 11 are connected with each other by the third connectors 40 in which the second portion 42 of each third connector 40 is installed to the positioning hole 126 of the smallest first cog 11, and the third portion 43 of each third connector 40 is installed to the aperture 134 of the third cog 13. Both sides of the first portion 41 abut against the first side 131 of the third cog 13 and the second side 112 of the smallest first cog 11, respectively, therefore, the third cog 13 and the smallest first cog 11 have a gap therebetween, preferably, the gap is equivalent to the width W″. Preferably, the second portion 42 has a cross-section the same with that of the positioning hole 116 of the smallest first cog 11, and the third portion 43 has a cross-section the same with that of the aperture 134 of the third cog 13, therefore, the third connector 40 is steadily disposed between the third cog 13 and the smallest first cog 11. The second portion 42 has a retaining portion 44 formed on one end thereof distal from the first portion 41. The third portion 43 has a retaining portion 45 formed on one end thereof distal from the first portion 41. The retaining portion 44 of the second portion 42 has a fourth diameter H4″ along the radial direction of the third connector 40, and the retaining portion 45 of the third portion 43 has a fifth diameter H5″ along the radial direction of the third connector 40. The fourth diameter H4″ of the retaining portion 44 is larger than the diameter of the positioning hole 116 of the smallest first cog 11 such that the smallest first cog 11 is restrained between the first portion 41 and the retaining portion 44. The fifth diameter H5″ of the retaining portion 45 is larger than the diameter of the aperture 114 of the third cog 13 such that the third cog 13 is restrained between the first portion 41 and the retaining portion 45. A diameter of the recess 1321 of the smaller first cog 11 is larger than the fifth diameter H5″ of the retaining portion 45 such that the retaining portion 45 is disposed in the recess 1321 of the third cog 13 and does not protrude from the second side 132 of the third cog 13, therefore, the third connector 40 would not interfere with respect to the chain while operating.

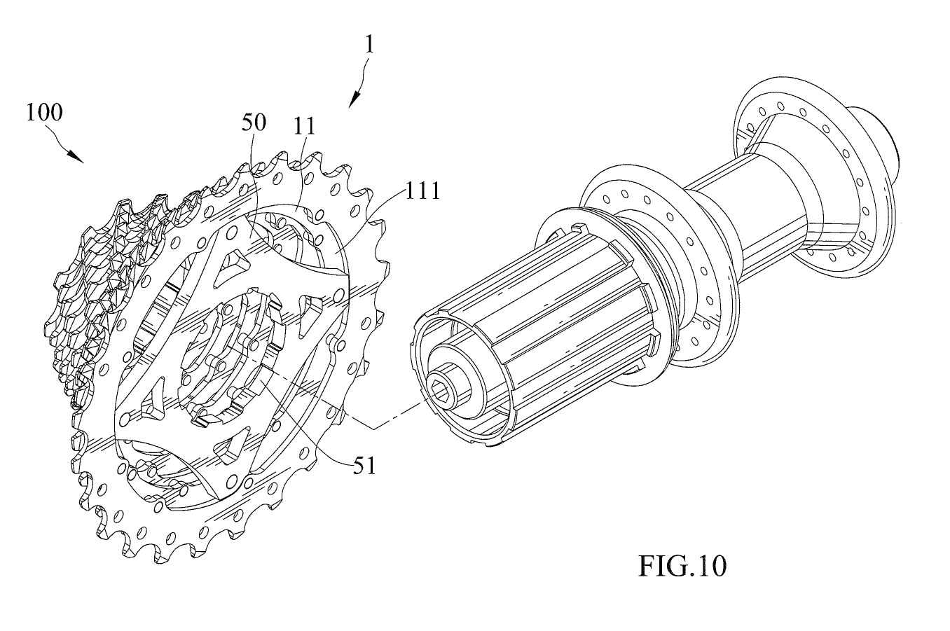

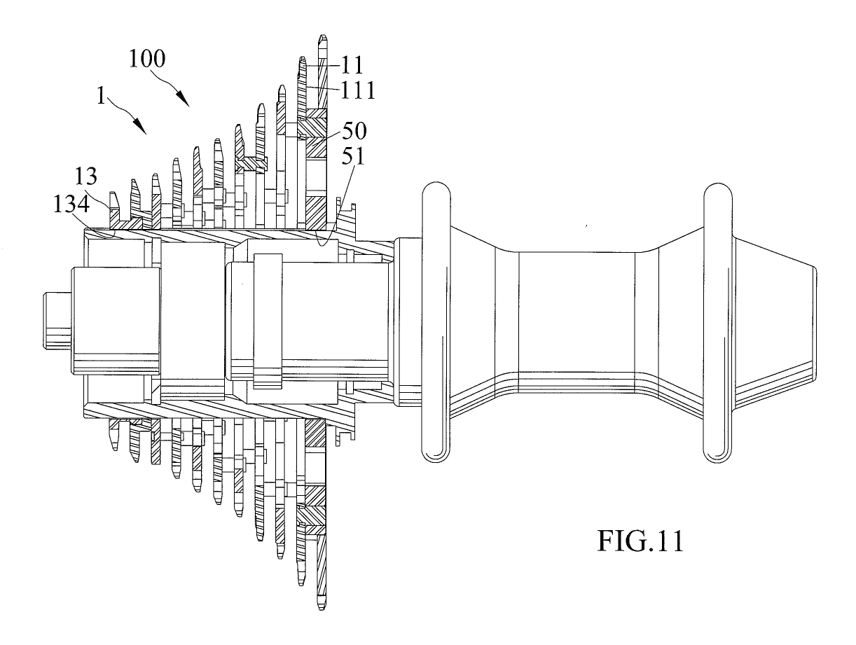

Referring to FIGS. 10 and 11, the cogset 1 further comprises a fixing element 50 installed to the first side 111 of the largest first cog 11. The fixing element 50 has an opening 51 extending therethrough, and the opening is adapted to connect to the rotatable hub. Hence, the cogset 1 is steadily connected to the rotatable hub due to that the rotatable hub is connected to the opening 51 of the fixing element 50 and the through hole 133 of the third cog 13.

Each of the first 11, second 12 and third 13 cogs is separately formed and is connected with each other by the connective set 200. In addition, each of the first 11 and second 12 cog is not directly connected to the rotatable hub so that the diameter of the through hole 113 and the through hole 123 can be maximized to decrease the weight of the cogset 1. In a preferred form, each of the first 20, second 30, and third 40 connectors has a profile the same with each other such that the cost is reduced.

While the specific embodiments have been illustrated and described, numerous modifications come to mind without significantly departing from the spirit of invention, and the scope of invention is only limited by the scope of the accompanying claims.

What is claimed is:

1. A cogset, which is adapted to connect to a rotatable hub in a bicycle, comprising:
a cog assembly and a connective set installed to the cog assembly;
wherein the cog assembly includes at least one first cog, a second cog connected to the first cog, and a third cog connected to the first cog, wherein each of the first, second and third cogs has a radial distance measured from a center thereof to an outer peripheral edge thereof, with the radial distance of second cog larger than the radial distance of any first cog, and the radial distance of any first cog larger than the radial distance of third cog, wherein each of the first and second cogs is not directly connected to the rotatable hub;
wherein each first cog includes a through hole extending therethrough, a first portion distal from the through hole and a second portion adjacent to the through hole, wherein each first portion has at least one aperture, wherein each second portion has at least one connected section adjacent to an inner periphery of the through hole, wherein each connected section has a positioning hole;
wherein the second cog includes a through hole extending therethrough, wherein the second cog has at least one connected section adjacent to an inner periphery of the through hole and corresponding to the aperture of the largest first cog, wherein each connected section has a positioning hole; and
wherein the third cog includes a through hole extending therethrough, wherein the third cog has at least one aperture and corresponding to the positioning hole of the smallest first cog.

2. The cogset as claimed in claim 1, wherein the connected section of each first cog is extended toward the center of related first cog.

3. The cogset as claimed in claim 1, wherein the connective set includes a first connector disposed between the largest first cog and a second connector disposed between the first cogs, wherein each of the first and second connectors has a first portion, a second portion and a third portion, respectively, wherein each of the first portions has a first diameter along a radial direction of related connector, each of the second portions has a second diameter along the radial direction of related connector, and each of the third portions has a third diameter along the radial direction of related connector, with the first diameter of each first portion larger than the second diameter of related second portion, and larger than the third diameter of related third portion;
wherein the second portion of the first connector corresponds to and is installed to the positioning hole of the second cog, and the third portion of the first connector corresponds to and is installed to the aperture of the largest first cog, wherein the second portion of the second connector corresponds to and is installed to the positioning hole of the larger first cog, and the third portion of the second connector corresponds to and is installed to the aperture of the smaller first cog;
wherein each of the first portions has a width along a longitudinal direction of related connector.

4. The cogset as claimed in claim 3, wherein each second portion has a cross-section the same with that of the positioning hole of related cog, and each third portion has a cross-section the same with that of the aperture of related cog.

5. The cogset as claimed in claim 3, wherein the second portion of the first connector has a retaining portion formed on one end thereof distal from the first portion, with the retaining portion of the first connector having a fourth diameter along the radial direction of the first connector, wherein the fourth diameter of the retaining portion is larger than the diameter of the positioning hole of the second cog such that the second cog is restrained between the first portion of the first connector and the retaining portion of the first connector.

6. The cogset as claimed in claim 3, wherein the third portion of the first connector has a retaining portion formed on one end thereof distal from the first portion, with the retaining portion of the first connector having a fifth diameter along the radial direction of the first connector, wherein the fifth diameter of the retaining portion is larger than the diameter of the aperture of the largest cog such that the largest first cog is restrained between the first portion of the first connector and the retaining portion of the first connector.

7. The cogset as claimed in claim 6, wherein the second side of the largest first cog has a recess formed thereon and in communication with related aperture, wherein a diameter of the recess of the largest first cog is larger than the fifth diameter of the retaining portion of the first connector.

8. The cogset as claimed in claim 1, wherein the aperture of each first cog and the center of the related first cog have a first distance therebetween, wherein the positioning hole of each first cog and the center of the related first cog have a second distance therebetween, wherein the second distance is smaller than the first distance.

9. The cogset as claimed in claim 1, wherein each of the first, second, and third connectors has a profile the same with each other such that the cost is reduced.

10. The cogset as claimed in claim 1 further comprising a fixing element installed to a first side of the largest first cog, with the first side adjacent to the second cog, wherein the fixing element has an opening extending therethrough, and the opening is adapted to connect to the rotatable hub.
